(19) United States
(12) Patent Application Publication
(10) Pub. No.: US 2014/0177660 A1
(43) Pub. Date: Jun. 26, 2014

(54) WAVELENGTH STABILIZATION

(71) Applicant: VOLCANO CORPORATION, San Diego, CA (US)

(72) Inventor: David Welford, Danvers, MA (US)

(73) Assignee: VOLCANO CORPORATION, San Diego, CA (US)

(21) Appl. No.: 14/109,279

(22) Filed: Dec. 17, 2013

Related U.S. Application Data
(60) Provisional application No. 61/781,352, filed on Mar. 14, 2013.
(60) Provisional application No. 61/745,405, filed on Dec. 21, 2012.

(51) Int. Cl. H01S 3/13

(52) U.S. Cl. CPC H01S 3/1305
USPC 372/20

(57) ABSTRACT

Systems and methods of the invention generally relate to feedback loops for wavelength stabilization. According to certain aspects, a method of the invention includes filtering light through a tunable filter configured to deliver a target wavelength of light, measuring the wavelength of the filtered light, detecting a change between the target wavelength and the filtered wavelength, and adjusting the tunable filter based on the detected change so that the filtered wavelength matches the target wavelength.

### RELATED APPLICATIONS

This application claims the benefit of and priority to U.S. Provisional Application No. 61/745,405, filed on Dec. 21, 2012, and U.S. Provisional Application No. 61/781,352, filed Mar. 14, 2013. The entireties of each are incorporated by reference herein.

### TECHNICAL FIELD

This invention generally relates to systems and methods for stabilizing wavelengths of optical systems.

### BACKGROUND

Optical systems are used in a variety of applications that require amplified light. Amplified light is provided by a light source that includes an optical amplifier. The optical amplifier includes a gain medium, which is a medium that can amplify the power of light (typically in the form of a light beam) from a low energy state to a higher energy state. The gain medium receives light from the light source (i.e. pumped with energy) and amplifies via stimulated emission, where photons of an incoming beam of light into the gain medium trigger the emission of additional photons.

For certain applications, such as medical imaging, it is desirable to provide a specific wavelength of the amplified light transmitted from the gain medium. In particular, optical coherence tomography imaging techniques use light of a particular wavelength to penetrate an imaging surface, such as human tissue and vessels, and measure the reflected light to produce a medical image. For optimal medical imaging, the desired wavelength should be stable and of a particular bandwidth. Because the optical properties of tissue depend on the wavelength used, it is necessary to provide a specific and stable wavelength to maximize the light penetration and enhance the image contrast at deeper depths. The overall effect produces an image with high resolution.

To achieve a specific wavelength of amplified light, a tunable optical filter can be coupled to the light source. Amplified light of a specific wavelength is obtained by introducing amplified light into the filter and tuning the filter to output light of the specific wavelength. Despite some advances in achieving a specific wavelength, current tunable filters are unable to maintain a consistently specific wavelength over a period of time due to mechanical fluctuations of the tunable filter caused by temperature, creep, and hysteresis.

### SUMMARY

The present invention provides for fast and simple way to maintain the wavelength of tunable filters using a feedback loop. In optical and laser systems, the invention comprises adjusting a tunable filter based on optical feedback from the light output of the tunable filter itself. The invention utilizes an optical feedback system that monitors the output of the tunable filter as compared to a desired output. For example, the feedback loop continually measures instantaneous wavelength output and compares that to a desired steady-state reference. If there is a detected change between an output wavelength and a target wavelength, the filter is adjusted so that the output wavelength matches the target wavelength.

In particular embodiments, a voltage is applied to the filter based on the detected change to stabilize output to a target wavelength. Thus, the invention provides for an optical feedback system to maintain the wavelength of light put out by a filter despite the presence of factors that cause fluctuation in the filter output wavelength.

Typical tunable optical filters, such as Fabry-Perot tunable filters, include piezoelectric elements between two optical fibers that are facing each other. The distance between optical fibers controls the wavelength of light transmitted from the optical filter. Expansion and contraction of the piezoelectric elements adjusts the distance between the optical fibers, and thereby adjusts the wavelength of light put out by the filter. Ideally, the piezoelectric elements would maintain a specific distance between the optical fibers due to a constant applied voltage to maintain a specific wavelength. However, most tunable filters are unable to maintain a consistently specific wavelength over a period of time due to fluctuations of the piezoelectric element. First, when a voltage is applied to the piezoelectric element, the piezoelectric element initially expands/contracts to the desired state, but over time the piezoelectric element begins to relax which increases or decreases the distance between the optical fibers and changes the wavelength. In addition, the expansion/contraction of the piezoelectric elements is temperature sensitive, e.g. the elements elongate due to application of high temperature. Due to the relaxation and temperature sensitivity, application of a constant voltage to the piezoelectric element and maintain the wavelength over a period of time.

Devices and methods of the invention correct creep and fluctuations of a filter's output wavelength caused by relaxation and contractions of the piezoelectric elements by monitoring a change in the outputted or instantaneous wavelength of the optical filter from a target wavelength and adjusting the optical filter based on the change. This advantageously corrects undesirable expansions/contractions of the piezoelectric element and provides a significantly more constant target wavelength.

Devices and methods of the invention are well-suited for use in a number of applications and optical systems, including medical imaging systems such as optical coherence tomography imaging systems. OCT imaging is particularly well-suited for imaging the subsurface of a vessel or lumen within the body, such as a blood vessel, for diagnostic purposes. In OCT imaging systems, a constant and specific wavelength produced by the imaging source results in better image resolution and quality. Because a physician is relying on the quality of the OCT image for diagnosis and course of treatment, image resolution and quality is critical.

In certain aspects, the optical feedback system includes laser that has a gain medium and a tunable filter coupled to the gain medium to produce a light of a target wavelength. A wavelength measuring module is coupled to receive light from the filter and to measure the wavelength of light outputted by the filter during operation. In addition, the wavelength measuring module detects any difference between the obtained output wavelength and a target wavelength. A controller is operably associated with the wavelength measuring module and the tunable filter. The controller receives a signal from the wavelength measuring module indicating that there is a difference between the outputted wavelength and the target wavelength. The controller also adjusts the tunable filter based on the difference so that the outputted wavelength matches the target wavelength.

By monitoring the wavelength of outputted light and detecting changes of the outputted light with respect to the target wavelength, the level of adjustment required to tune the tunable filter can be obtained. In certain embodiments, the wavelength of outputted light correlates to a voltage signal. In this embodiment, the optical feedback system utilizes a voltage signal representing the output wavelength to determine an appropriate voltage required to tune the tunable filter. For example, a wavelength measuring module receives the output wavelength and converts the output wavelength into a voltage signal. The voltage signal representing the output wavelength is then compared with a voltage signal proportional to and representing a target wavelength. Differences between the voltage signal of the output wavelength and the voltage signal of the target wavelength indicate a need to adjust the tunable filter. If a difference is detected, the wavelength measuring module sends a feedback signal to the controller. The controller then applies a control voltage signal based to the tunable filter configured to adjust the outputted wavelength so that it matches the target wavelength.

Adjusting the tunable filter can be accomplished by any technique known in the art. In one embodiment, the controller adjusts the filter by adjusting a voltage delivered to the filter. The tunable filter can be adjusted by increasing or decreasing the voltage so that the output wavelength matches the target wavelength. In addition to controlling the output wavelength, the adjusted voltage may stabilize the temperature of the tunable filter.

Devices and methods of the invention include optical components such as a gain medium and a tunable filter. A gain medium may include an optical amplifier. Any optical amplifier and tunable filter known in the art may be is suitable for use in accordance to the invention. In certain applications, the optical amplifier is a semiconductor optical amplifier. In certain embodiments, the tunable filter includes a pizeoelectric element, which is also known as a piezoelectric transducer. An example of a tunable filter with a pizeoelectric element is a Fabry-Perot Filter.

### BRIEF DESCRIPTION OF DRAWINGS

FIG. 1 illustrates a block diagram of an optical feedback system in accordance to certain embodiments.

FIG. 2 illustrates a ring laser suitable for use in the optical feedback system.

FIG. 3 illustrates photon emission.

FIG. 4 is a schematic diagram of a semiconductor optical amplifier.

FIG. 5 shows the emission wavelengths of semiconductor materials.

FIG. 6 depicts a tunable filter according to some embodiments.

FIG. 7 illustrates an embodiment of the optical feedback system outlined in FIG. 1.

FIG. 8 depicts the transmission of a linear filter suitable for use in optical feedback systems of the invention

FIG. 9 is a high-level diagram of a system for optical coherence tomography.

FIG. 10 is a schematic diagram of the imaging engine of an OCT system.

FIG. 11 is a diagram of a light path in an OCT system.

FIG. 12 shows the organization of a patient interface module in an OCT system coupled to an imaging engine.

FIG. 13 shows the natural resonance frequency of a tunable filter.

### DETAILED DESCRIPTION

The invention generally relates to an optical feedback system for stabilizing the wavelength of an optical system. The invention is implemented with an optical feedback system. The optical feedback system monitors the outputted or instantaneous wavelength emitted from an optical filter and compares the outputted wavelength to a target wavelength. In certain embodiments, the optical feedback system monitors and compares the outputted wavelength via voltage signals that are proportional to and representative of the outputted wavelength and target wavelength. If there is a detected change between the outputted wavelength and the target wavelength, the filter is adjusted so that the outputted wavelength matches the target wavelength. Thus, the invention provides for an optical feedback system to maintain the wavelength of light outputted by a filter despite the presence of factors that fluctuate the filter output wavelength.

Devices and methods of the invention are directed to regulating the wavelength of tunable filters used in optical systems, such as lasers. The advantages of tunable lasers include high spectral brightness and relatively simple optical designs. A tunable laser is constructed from a gain medium, such as a semiconductor optical amplifier (SOA), which is located within a resonant cavity, and a tunable filter, such as a Fabry-Perot tunable filter. The tunable filter may operate to transmit a target wavelength while rejecting other wavelengths. A tunable filter is also adjustable by application of a suitable control signal, such as a voltage or an acoustic signal. Any tunable filter is suitable for use in device and methods of the invention. A Fabry-Perot tunable filter is tuned to a target wavelength by applying suitable voltages. Acousto-optical filters are tuned to a target wavelength by applying suitable radio frequencies. Typically, all tunable filters are unable to maintain the target wavelength over periods of time due to creep and relaxation of the tunable filter. Therefore, there is a need for a feedback loop to monitor and stabilize the output wavelength of tunable filters.

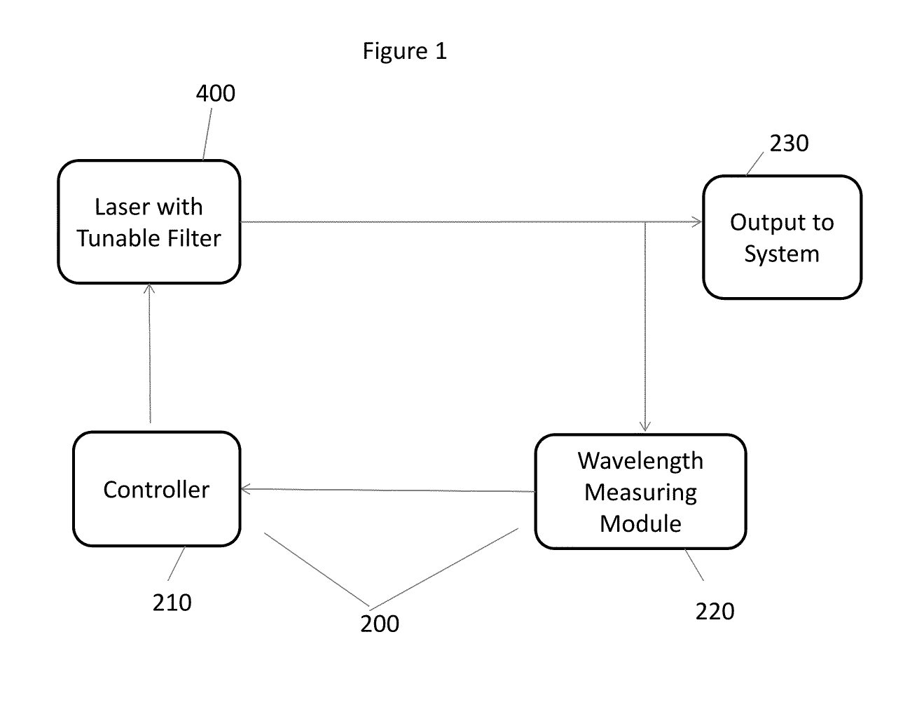

FIG. 1 illustrates a block diagram of an optical feedback system 200 in accordance to certain embodiments. The optical feedback system 200 is configured to stabilize the wavelength of tunable filter optical systems. The optical feedback system 200 includes a wavelength measuring module 220 and a controller 210 for monitoring and adjusting wavelengths transmitted from a laser with a tunable filter 400. The optical feedback system 200 is coupled to a laser with a tunable filter 400. The laser with a tunable filter 400 is configured to output light of a specific wavelength (although the instantaneous wavelength may alter as discussed due to creep and thereby requires monitoring and adjustment by the optical feedback system). The output light is spilt, and a portion of the output light is transferred to an optical system 230 (i.e. optical coherence tomography system) and another portion is transferred to the wavelength measuring module 220. The wavelength measuring module 220 measures the actual wavelength of the light outputted from the laser with tunable filter 400 and compares the outputted wavelength against a reference wavelength of light (i.e. target wavelength). In certain embodiments, the outputted wavelength is converted to a voltage signal, and the voltage signal of the outputted wavelength is compared to a voltage signal representative of a voltage signal of the target wavelength. After the comparison step, the wavelength measuring module 220 sends a feedback signal to the controller 210. Based on the feedback signal, the controller 210 sends a control signal to adjust the tunable filter of the laser 400 so that the output wavelength matches the reference or target wavelength.

If the wavelength measuring module 220 detects a difference between the outputted wavelength and the reference wavelength, the wavelength measuring module 220 transmits a negative feedback signal to the controller 220. Based on the negative feedback signal, the controller 210 transmits a control signal to the laser 400 to adjust the tunable filter. Preferably, the control signal is a voltage, but is contemplated that the control signal may include any suitable signal for adjusting a tunable filter. For example, Fabry-Perot tunable filters include piezoelectric elements that are tunable by applying suitable voltages, whereas acousto-optical filters are tunable by applying radio-frequencies.

The control signal applied to the laser with the tunable filter 400 adjusts the tunable filter so that the outputted light matches the target wavelength. The magnitude of the control applied to the laser with the tunable filter 400 varies according to the magnitude of the difference between the outputted wavelength and the reference wavelength. The laser with the tunable filter 400 receives the control signal from the controller 210 and the tunable filter of the laser 400 is adjusted to output light of the target wavelength. The adjusted light outputted from the laser 400 is then split sending a portion of the adjusted light to the optical system 230 and a portion through the optical feedback system 200. In this manner, the optical feedback system 200 continually acts to stabilize the wavelength of the laser 400 during operation.

The wavelength measuring module 220 can include any suitable device that compares the instantaneous output wavelength with a reference wavelength and generates a feedback signal to the controller based on the comparison. The wavelength measuring module 220 may be a bipolar phototransistor, a photoFET, or any other device capable of performing an optical-to-electrical conversion of the wavelength. In certain embodiments, the wavelength measuring module 220 further includes one or more optical-to-electrical conversion elements to generate the voltage signal of the wavelength. The optical-to-electrical conversion element can be a photodiode. In one embodiment, the wavelength measuring module 220 includes a wavelength discrimination element. The wavelength discrimination element is used to obtain the output wavelength measurement and to eliminate noise or other fluctuations from affecting the output wavelength measurement. In one embodiment, the wavelength discrimination element is a linear transmission optical filter. In addition, the wavelength measuring module includes one or more elements that compare the converted wavelength to a reference signal to generate a feedback signal and pass the feedback signal to the controller.

The controller 210 generates control signals based on the feedback signal received from the wavelength measuring module 220. The controller 210 can include any device or circuitry capable of receiving the feedback signal and transmitting an appropriate control signal to the tunable filter of the laser. For example, the controller can include application specific integrated circuits, field programmable gate arrays, and digital signal processors, all of which include logic for determining the amount of voltage required to tune the tunable filter. The control signal may include a voltage, a radio frequency, or any other signal for adjusting the tunable filter. For Fabry-Perot tunable filters, the control signal is a voltage.

In one embodiment, the controller includes an integrator and a drive amplifier. In this embodiment, the wavelength measuring module 220 send the feedback signal to the controller 210 that disables or enables the controller 210 by enabling or disabling the integrator using a switch across an integrator capacitor. When the controller is enabled (creating open-loop condition), the drive amplifier applies a voltage to the tunable optical filter of the laser 400 to manipulate the output wavelength. The optical feedback system continues to deliver a voltage to the tunable optical filter until the output wavelength stabilizes to the target wavelength. The drive amplifier can be specific to the tunable optical filter. For example, the Fabry-Perot tunable filters often cannot be driven with negative voltage so the drive amplifier may have certain high and low voltage limits to protect the tunable filter.

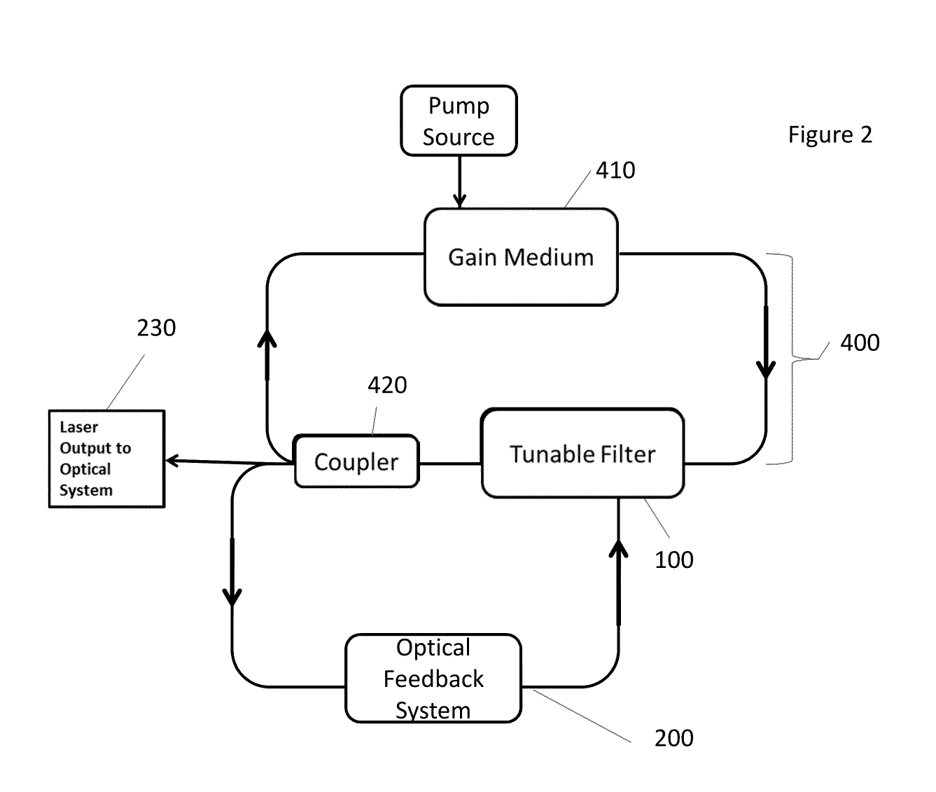

Tunable lasers (i.e. amplified light sources) suitable for use in the optical feedback system include a tunable filter and a gain component. In certain embodiments, the laser is a ring laser. FIG. 2 illustrates a ring laser 400 suitable for use in the optical feedback system. As shown in FIG. 2, the laser 400 includes a tunable filter 100 and a gain component 410. In order to generate laser light with the ring laser, light is pumped through the gain component 410. The gain component 410 amplifies the light and the amplified light is transferred to the tunable filter 100. The tunable filter 100 takes the amplified light and generates light of a specified wavelength. The filtered light is then transferred into a coupler 420. The coupler 420 sends a portion of the filtered light back through the ring laser 400, a portion of the filtered light to an optical system 230 (e.g. an imaging system), and a portion of the filtered light to the optical feedback system 200.

The gain component and the tunable filter of the tunable laser suitable for use in the optical feedback system are described in more detail below.

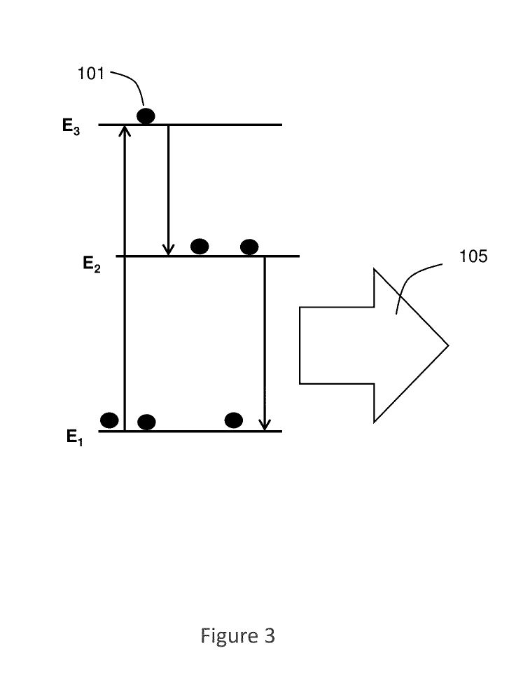

The gain component amplifies the power of light that is transmitted through it. When light interacts with material, a few outcomes may be obtained. Light can be transmitted through the material unaffected or reflect off of a surface of the material. Alternatively, an incident photon of light can exchange energy with an electron of an atom within the material by either absorption or stimulated emission. As shown in FIG. 3, if the photon is absorbed, the electron 101 transitions from an initial energy level E1 to a higher energy level E2 (in three-level systems, there is a transient energy state associated with a third energy level E3).

When electron 101 returns to ground state E1, a photon 105 is emitted. When photons are emitted, there is net increase in power of light within the gain medium. In stimulated emission, an electron emits energy ΔE through the creation of a photon of frequency v₁₂ and coherent with the incident photon. Two photons are coherent if they have the same phase, frequency, polarization, and direction of travel. Equation 1 gives the relationship between energy change ΔE and frequency v₁₂:

ΔE=hv₁₂ (1)

where h is Plank's constant. Light produced this way can be temporally coherent, i.e., having a single location that exhibits clean sinusoidal oscillations over time.

An electron can also release a photon by spontaneous emission. Amplified spontaneous emission (ASE) in a gain medium produces spatially coherent light, e.g., having a fixed phase relationship across the profile of a light beam.

Emission prevails over absorption when light is transmitted through a material having more excited electrons than ground state electrons—a state known as a population inversion. A population inversion can be obtained by pumping in energy (e.g., current or light) from outside. Where emission prevails, the material exhibits a gain G defined by Equation 2:

G=10 Log₁₀(Pₒᵤₜ/Pᵢₙ) dB (2)

where Pₒᵤₜ and Pᵢₙ are the optical output and input power of the gain medium.

A gain component, generally, refers to any device known in the art capable of amplifying light such as an optical amplifier or any component employing a gain medium. A gain medium is a material that increases the power of light that is transmitted through the material. Exemplary gain mediums include crystals (e.g., sapphire), doped crystals (e.g., yttrium aluminum garnet, yttrium orthovanadate), glasses such as silicate or phosphate glasses, gasses (e.g., mixtures of helium and neon, nitrogen, argon, or carbon monoxide), semiconductors (e.g., gallium arsenide, indium gallium arsenide), and liquids (e.g., rhodamine, fluorescein).

A gain component can be an optical amplifier or a laser. An optical amplifier is a device that amplifies an optical signal directly, without the need to first convert it to an electrical signal. An optical amplifier generally includes a gain medium (e.g., without an optical cavity), or one in which feedback from the cavity is suppressed. Exemplary optical amplifiers include doped fibers, bulk lasers, semiconductor optical amplifiers (SOAs), and Raman optical amplifiers. In doped fiber amplifiers and bulk lasers, stimulated emission in the amplifier's gain medium causes amplification of incoming light. In semiconductor optical amplifiers (SOAs), electron-hole recombination occurs. In Raman amplifiers, Raman scattering of incoming light with phonons (i.e., excited state quasiparticles) in the lattice of the gain medium produces photons coherent with the incoming photons.

Doped fiber amplifiers (DFAs) are optical amplifiers that use a doped optical fiber as a gain medium to amplify an optical signal. In a DFA, the signal to be amplified and a pump laser are multiplexed into the doped fiber, and the signal is amplified through interaction with the doping ions. The most common example is the Erbium Doped Fiber Amplifier (EDFA), including a silica fiber having a core doped with trivalent Erbium ions. An EDFA can be efficiently pumped with a laser, for example, at a wavelength of 980 nm or 1.480 nm, and exhibits gain, e.g., in the 1.550 nm region. An exemplary EDFA is the Cisco ONS 15501 EDFA from Cisco Systems, Inc. (San Jose, Calif.).

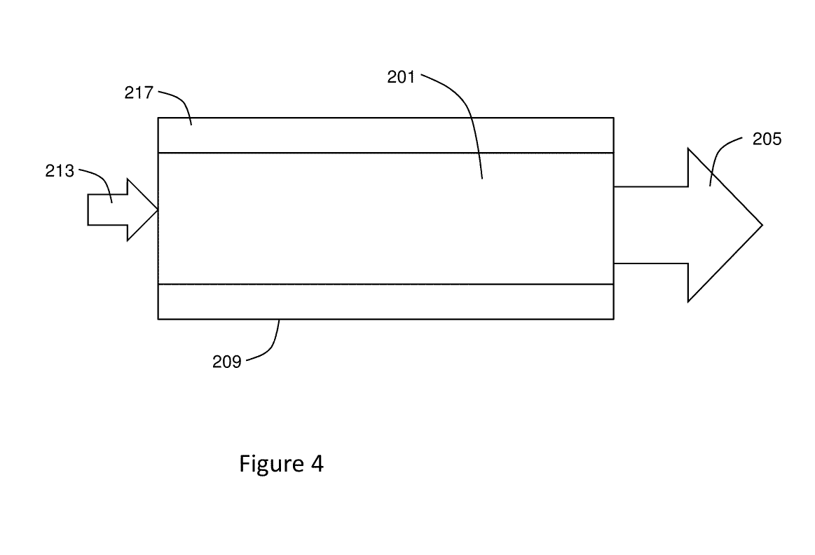

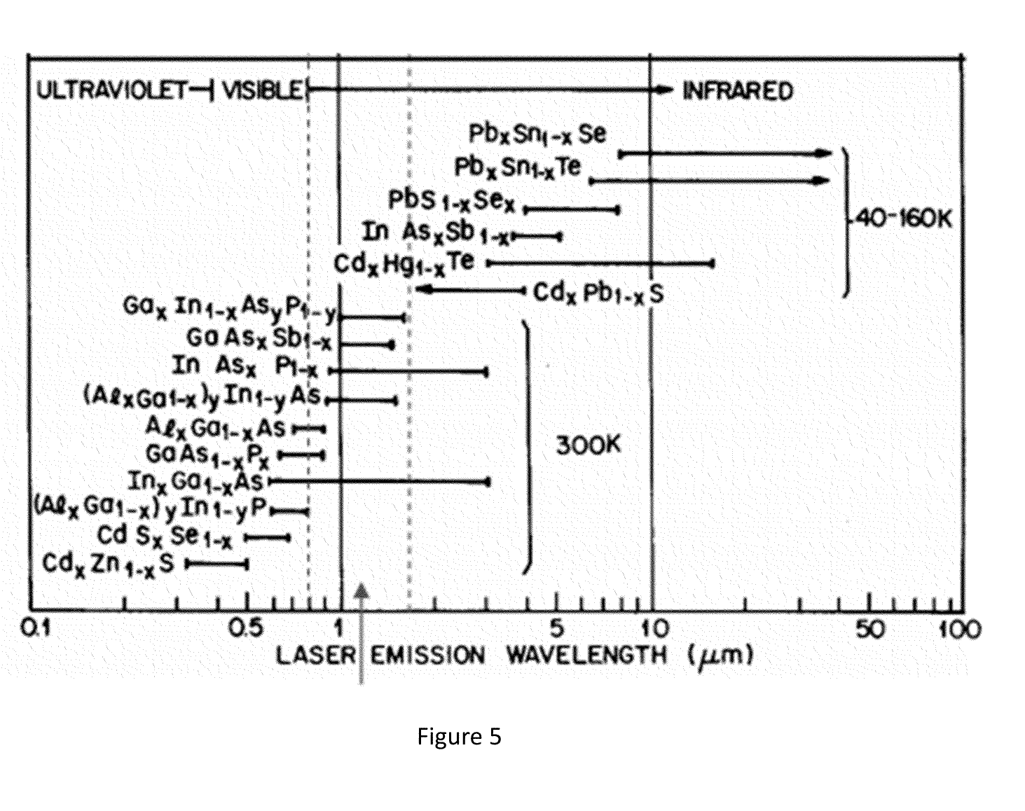

Semiconductor optical amplifiers (SOAs) are amplifiers that use a semiconductor to provide the gain medium. FIG. 4 is a schematic diagram of a semiconductor optical amplifier. Input light 213 is transmitted through gain medium 201 and amplified output light 205 is produced. An SOA includes n-cladding layer 217 and p-cladding layer 209. An SOA typically includes a group III-V compound semiconductor such as GaAs/AlGaAs, InP/InGaAs, InP/InGaAsP and InP/InAlGaAs, though any suitable semiconductor material may be used. FIG. 5 shows the emission wavelengths of semiconductor materials.

A typical semiconductor optical amplifier includes a double heterostructure material with n-type and p-type high band gap semiconductors around a low band gap semiconductor. The high band gap layers are sometimes referred to as p-cladding and n-cladding layers (having, by definition, more holes than electrons and more electrons than holes, respectively). The carriers are injected into the gain medium where they recombine to produce photons by both spontaneous and stimulated emission. The cladding layers also function as waveguides to guide the propagation of the light signal. Semiconductor optical amplifiers are described in Dutta and Wang, Semiconductor Optical Amplifiers, 297 pages, World Scientific Publishing Co. Pte. Ltd., Hackensack, N.J. (2006), the contents of which are hereby incorporated by reference in their entirety.

Booster Optical Amplifiers (BOAs) are single-pass, traveling-wave amplifiers that only amplify one state of polarization generally used for applications where the input polarization of the light is known. Since a BOA is polarization sensitive, it can provide desirable gain, noise, bandwidth, and saturation power specifications. In some embodiments, a BOA includes a semiconductor gain medium (i.e., is a class of SOA). In certain embodiments, a BOA includes an InP/InGaAsP Multiple Quantum Well (MQW) layer structure.

The tunable laser for use with the optical feedback system can include a tunable filter. The tunable filter is in communication with the gain component. Optical filters are discussed in U.S. Pat. No. 7,035,484; U.S. Pat. No. 6,822,798; U.S. Pat. No. 6,459,844; U.S. Pub. 2004/0028333; and U.S. Pub. 2003/0194165, the contents of each of which are incorporated by reference herein in their entirety. A tunable optical filter typically has a peak reflectivity and a background reflectivity. The peak reflectivity indicates an amount of light output (reflected) at the specified wavelength, wherein a desired wavelength can be set (in a tunable filter) by placing reflective surfaces in an etalon an appropriate distance apart. The background reflectivity indicates an amount of light output at wavelengths other than the desired wavelength.

In certain embodiments, the optical feedback system stabilizes the wavelength of light outputted by an optical-electrical tunable filter, such as a Fabry-Perot tunable filter. Fabry-Perot tunable filters including one or more piezoelectric elements and at least two optical reflective surfaces. Typically, the reflective surfaces are coupled to end faces of optical fibers. As discussed, the distance between the reflective surfaces corresponds to the wavelength outputted by the filter. In order to achieve a specific wavelength, a voltage may be applied to the piezoelectric elements within the tunable filter causing the piezoelectric elements to expand and contract. That expansion and contractions adjusts the distance between the reflective surfaces within the tunable optical filter.

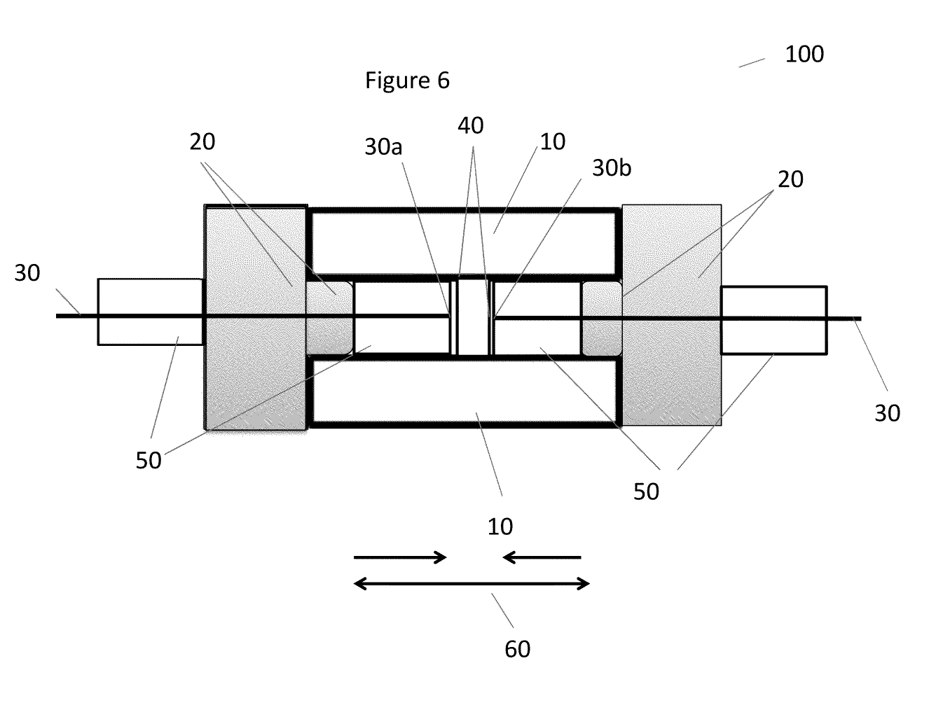

FIG. 6 depicts a tunable filter according to some embodiments. The tunable filter 100 is a Fabry-Perot tunable filter. The tunable filter 100 includes piezoelectric elements 10 coupled to two alignment fixtures 20. The optical fibers 30 are positioned between the piezoelectric elements 10. The optical fibers 30 are disposed within ferrules 50 to minimize stress and strain. Ends of fibers 30a and 30b face each other and two dielectric minors 40 deposited onto the fiber ends 30a and 30b form a cavity. Expansion and contraction (as indicated by arrows 60) of the piezoelectric elements 10 can change the distance between optical fibers 30, which increases or decreases the wavelength.

Once the tunable filter obtains the specific wavelength, one must maintain the distance between the optical fibers to maintain the wavelength. During operation of an optical system or laser, undesirable relaxation of the piezoelectric elements causes a change in the distance between the optical fibers, thus altering the wavelength. That undesirable relaxation of the piezoelectric elements can be caused by, for example, the piezoelectric elements becoming accustomed to the applied voltage. In addition, during operation, the tunable filter within the laser cavity increases with temperature. The change in temperature can cause the piezoelectric element to expand and contract also resulting in a change in wavelength.

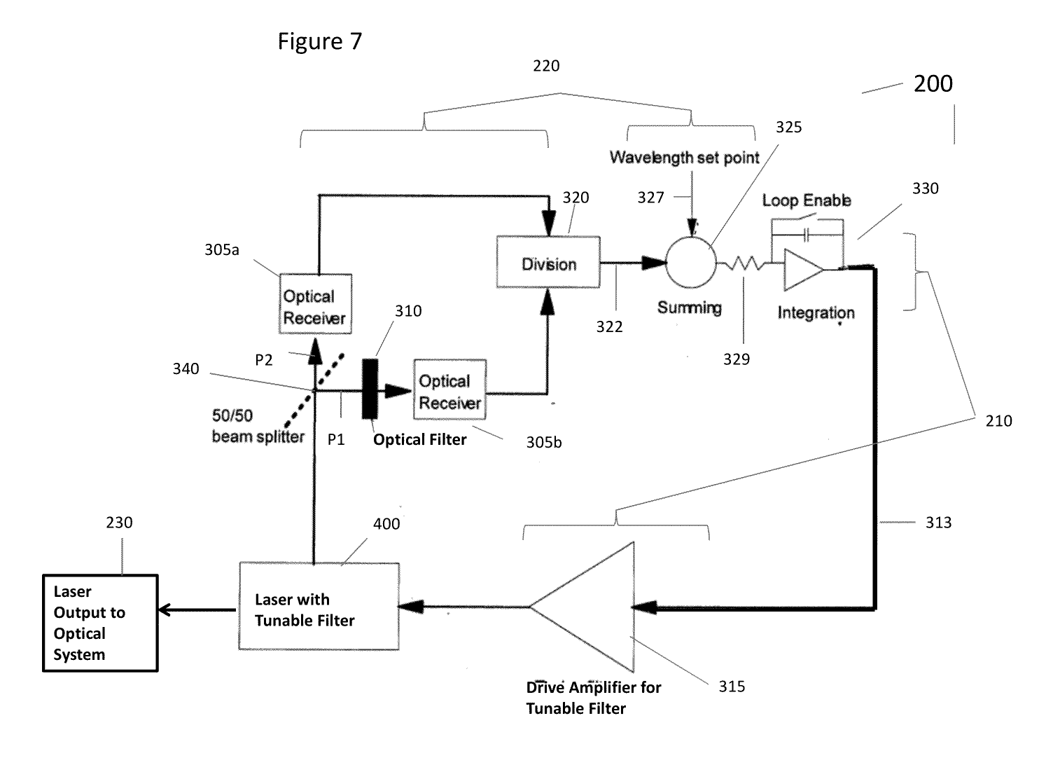

FIG. 7 illustrates an embodiment of an optical feedback system 200 of the invention. The optical feedback system 200 includes a laser with a tunable filter 400, a wavelength measuring module 220, and a controller 210. The wavelength measuring module 220 includes a beam splitter 340, an optical filter 310, optical receivers 305a and 305b, a division function 320 and a summing function 325. The wavelength measuring module 220 is configured to measure the output wavelength of light and generate a normalized voltage signal proportional to the wavelength of outputted light. In addition, the wavelength measuring module 220 compares the voltage signal of the outputted light to a voltage signal proportional to a target wavelength of light and generates a feedback signal based on the comparison. The feedback signal is sent to the controller 210. The controller includes integration function 330 and drive amplifier 315 for the tunable filter. The controller 210 transfers a control signal, which is based on the feedback signal, configured to adjust the laser with a tunable filter so that the output wavelength matches the target wavelength. The operation of the optical feedback system, as shown in FIG. 7 is described in more detailed below.

The laser with a tunable filter 400, such as the laser depicted in FIG. 2, outputs light of a certain wavelength. The output light is divided and a portion of the outputted light is transmitted to an optical system 230 and another portion is transmitted through the optical feedback system 200.

The portion of light transmitted to the optical feedback system 200 is transferred through the wavelength measuring module 220. Optionally and as shown, the outputted light transmitted through the optical feedback system is split via a beam splitter 340. Alternatively, a 50/50 coupler can be used to split the portion of outputted light sent through the wavelength measuring module 220. However, couplers are wavelength dependent and may corrupt wavelength discrimination of the optical filter 310. A portion of the light is transmitted through path P1 and a portion of the light is transmitted through path P2.

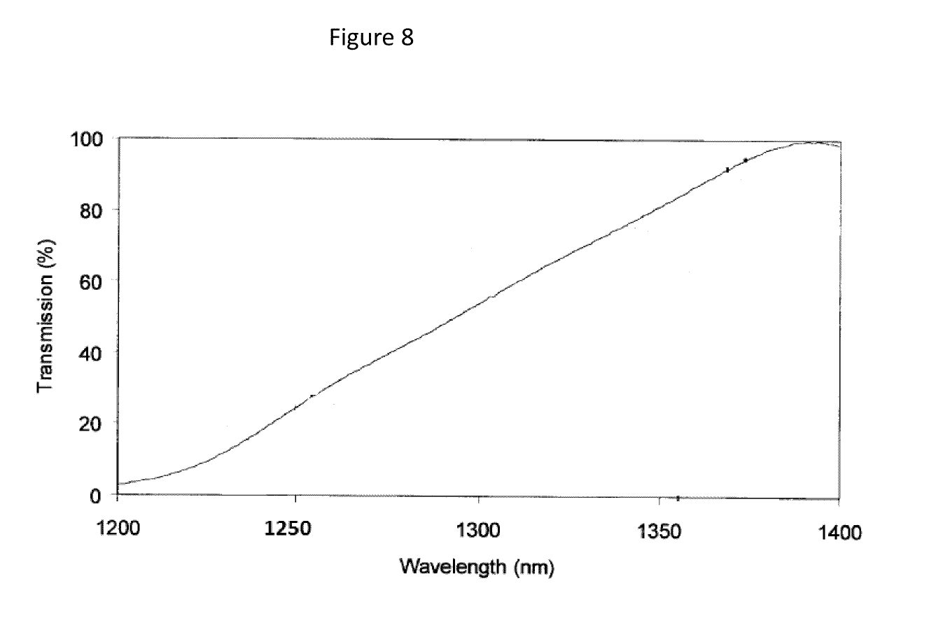

Light transmitted through P1 is transmitted through optical filter 310 and optical receiver 305b. The optical filter 310 provides the wavelength discrimination function. The optical filter 310 transfers of wavelengths of light within a range of light representative of the potential laser output and prevents transfer of wavelengths outside of that discrimination. Preferably, the optical filter is a linear optical filter. In certain embodiments, the output wavelength is modulated (e.g. in the case of swept-source lasers), and the optical filter 310 includes a bandwidth configured to at least transmit light having wavelengths within the modulation range. FIG. 8 depicts the transmission of a linear filter suitable for use in optical feedback systems of the invention. After light following the P1 path passes through the optical filter 310, the filtered light is then transmitted through optical receiver 305b. Optical receiver 305b converts the filtered light of an output wavelength into a voltage signal. The optical receiver 305b includes a photodiode (e.g. Germanium PIN photdiode) and a transimpedance amplifier. The photodiode converts the filtered outputted light into a current. The photodiode current is then converted to a voltage proportional to the optical source wavelength using the transimpedance amplifier.

Light following through P2 is transmitted through optical receiver 305a. Optical receiver 305b converts unfiltered output light received directly from the laser with tunable filter into a voltage signal. Optical receiver 305a, like optical receiver 305b, includes a photodiode (e.g. Germanium PIN photdiode) and a transimpedance amplifier. The photodiode converts the unfiltered outputted light into a current. The photodiode current is then converted to a voltage using the transimpedance amplifier.

The voltage signal of the unfiltered light from optical receiver 305a is used to track the intensity of the tunable laser and provide a means to normalize the voltage signal of the filtered light (i.e. light through path P1). For normalization, the voltage of the filtered light and the voltage of the unfiltered light are combined and normalized via division 320. This normalization prevents intended intensity variations from degrading the operation of the optical feedback loop. For example, normalization prevents tuning variations in optical intensity (e.g. those caused by modulation of the light source in swept-source laser) from degrading the optical feedback loop.

The normalized voltage signal 322 is then transferred to a summing function 325. The summing function 325 is coupled to a voltage source configured to generate a reference voltage signal 327 that corresponds with a reference or target wavelength of light and is of opposite polarity to the normalized voltage signal 322 of the outputted light received from the division function 230. At the summing function 325, the reference voltage signal 327 of the target wavelength is combined with the normalized voltage signal 322 of the outputted light. A difference between the voltage signals generates an error signal, which serves as the feedback signal 329. The feedback signal 329 is then sent to the integration function 330 of the controller 210. The feedback signal 329 serves to disable or enable the integrator via a switch. If enabled or in open loop condition (i.e. switch across the integrator is closed), the integrator sends a control signal 313 to the drive amplifier 315 for the tunable filter. Based on the control signal 313, the drive amplifier 315 for the tunable filter applies a voltage to the tunable filter of the laser 400. As wavelength is increased and error signal between the voltage signal of the output wavelength and the voltage signal of the target wavelength deceases, the control signal 313 decreases and slows the tuning. The adjustment of the tunable filter of the laser 400 continues until the output wavelength is locked to the target wavelength.

In certain aspects, the laser used in conjunction with an optical feedback system of the invention is a swept-source laser and is used in an optical coherence tomography system (swept-source OCT). Swept source OCT time-encodes spectral information by sweeping a narrow linewidth laser through a broad optical bandwidth. Swept source OCT uses a photodiode detector to measure photocurrents integrated over the line width. Swept-source lasers utilize tunable filters with a piezoelectric element to control and sweep the wavelength of the optical source. Typically, the piezoelectric element is driven by a frequency wave (i.e. drive frequency), which generates the forward and backward sweeps. During the forward sweep, the voltage applied to the piezoelectric element is increased to sweep the source output from shorter to longer wavelengths. During the backward sweep, the voltage applied to the piezoelectric element is decreased to sweep the source output from longer to shorter wavelengths. The intensity of the forward sweep is generally higher than the backward sweep. As a result, data collected from the forward sweep is used for practical applications, such as imaging.

For swept-source optical coherence tomography applications, the forward and backward sweeping occurs at high frequency rates and typically causes a wavelength modulation of about 100 nm. An exemplary swept source emits amplified light with an instantaneous line width of 0.1 nm that is swept from 1250 to 1350 nm. For example, the target wavelength of the tunable filter has constant, target wavelength 1300 nm (+ or −0.1 nm), which ranges from 1250 to 1350 nm during sweeping. For example, the amplified light or laser, during the unswept state, should have a constant target wavelength of about 1300 nm (+ or −0.1 nm), and, during the swept state, the target wavelength will range from 1250 to 1350 due to the intended modulation of 100 nm about the target wavelength of the unswept state. In order to accommodate sweeping frequency changes, the optical filter 310 (i.e. wavelength discrimination function) of the optical feedback system may include a wavelength range that accounts for the intended wavelength modulation due to the sweeping light source. For example, if a swept-source laser has a variable target wavelength that ranges from 1250 to 1350 due to the intended modulation of 100 nm about the unswept target wavelength of 1300, the optical filter 310 includes a bandwidth configured to at least transmit light having wavelengths within the modulation range.

For swept-source optical imaging systems, the swept-source drive frequency of the filter correlates to the image quality of the obtained images. With higher drive frequencies, the optical imaging system produces more forward and backward sweeps over a period of time, which in turn provides more imaging data over time. The ability to obtain more imaging data over a period of time is highly desirable. For example, optical coherence tomography catheters, which use swept-source tunable lasers, are often used to image the vasculature of an individual. In order to obtain an image with the catheter, blood within the vasculature must be temporarily replaced by a clear saline solution for a short period of time to clear the vessel for imaging. Thus, the quality of the image is limited to the amount of data the catheter can obtain during the flushing period.

However, due to some limitations of tunable filters, the drive frequency cannot simply be raised to increase the image quality. For example, over increasing the drive frequency reduces the coherence length of the output wavelength. Potential maximum imaging depth for a swept-source optical system is given by one half the coherence length of the system source, where the coherence length is inversely proportional to the dynamic line width of the swept source. As a result, it is undesirably to increase the drive frequency such that the coherence length prevents imaging objects at certain depths. In addition, higher drive frequencies may cause the piezoelectric elements to resonate irregularly, which may lead to decreased signal-to-noise and image resolution.

According to certain aspects, the invention provide for using a certain drive frequency to improve the quality and consistency of the laser output, which leads to overall better imaging. These aspects are accomplished by driving the tunable filter at its natural resonance frequency, thereby operating the tunable filter at its mechanical resonance. Natural resonance frequency is the frequency at which a system naturally vibrates once it has been set in motion without the influence of outside interference. Mechanical resonance is achieved by driving a system at or near the same frequency as its natural frequency. The mechanical resonance is the tendency of a system to responds at greater amplitude when the frequency of its oscillations matches or is near the system's natural resonance frequency. Resonance of the tunable filter is the oscillation of the piezoelectric elements, which in turn move the optical fibers. When a tunable filter is driven at its natural resonance frequency, the tunable filter oscillates in a more reproducible fashion, and provides a more reliable, regular sweeping pattern. This provides significant improvement in the imaging data obtained within a time period, without having to increase the rate of the drive frequency.

A method according to these aspects includes determining the natural frequency of a swept-source tunable filter in an optical system, and driving the swept-source tunable filter with a frequency about the natural frequency. In certain embodiments, the drive frequency is the same as the natural frequency. Alternatively, the drive frequency is any frequency near the natural frequency that causes mechanical resonance of the tunable filter. Those frequencies may be for example +/−0.5 kHz, +/−1 kHz, +/−5 kHz from the natural frequency of a tunable filter.

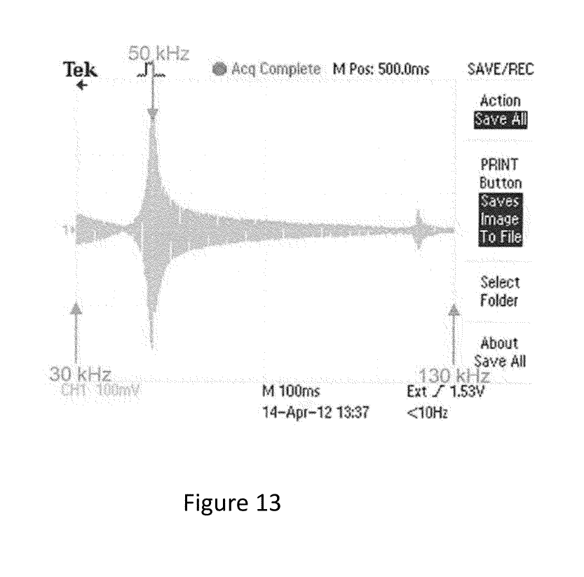

Any method known in the art may be used to determine the natural frequency of a tunable filter. Tunable optical filters may have one or more natural frequencies. In one example, the natural frequency of the tunable filter may be measured by capturing the peak-to-peak voltage across a tunable filter with a modulation frequency swept across a broad range of frequencies over a time period. Any range of frequencies expected to include a natural frequency may be chosen. For example, a tunable filter may be swept from 20 kHz to 200 kHz. The electrical impedance of the tunable filter, which directly correlates with the optical modulation response of the tunable filter, is measured during the sweep. Dominant impedance signals measured in response to a certain frequency in the sweep indicates a natural frequency of the filter. For example, FIG. 13 shows the peak-to-peak voltage across a 35-pm bandwidth tunable filter being swept from 30 kHz to 130 kHz. As shown in FIG. 13, the filter has a single dominant resonance in response to about 50 kHz, which indicates that the filter's natural frequency is about 50 kHz.

Use of a drive frequency that matches or is near a tunable filter's natural frequency may be used to improve the quality of imaging data in any optical imaging system. A preferred application for driving a tunable filter at its natural frequency is with optical coherence tomography systems. For optimal imaging, one may drive a tunable filter at its natural frequency and subject the tunable filter to the optical feedback system described herein.

The present invention can operate to stabilize a light source for a variety of uses and optical systems, including an imaging system. For example, laser output that has been stabilized by the optical feedback system may be transmit to a system that includes an interferometer (e.g. an a fiber optic interferometer). An interferometer, generally, is an instrument used to interfere waves and measure the interference. Interferometry includes extracting information from superimposed, interfering waves. Any interferometer known in the art can be used. In certain embodiments, an interferometer is included in a Mach-Zehnder layout, for example, using single mode optical fibers. A Mach-Zehnder interferometer is used to determine the relative phase shift between two collimated beams from a coherent light source and can be used to measure small phase shifts in one of the two beams caused by a small sample or the change in length of one of the paths.

In certain embodiments, the laser output of the laser with a tunable filter is directed to an optical tomography (OCT) system. Systems and methods of the invention are particularly amenable for use in OCT as the provided systems and methods can improve image quality and reduce the incidence of parasitic lasing.

Measuring a phase change in one of two beams from a coherent light is employed in optical coherence tomography. Commercially available OCT systems are employed in diverse applications, including art conservation and diagnostic medicine, e.g., ophthalmology. Recently, it has also begun to be used in interventional cardiology to help diagnose coronary heart disease. OCT systems and methods are described in U.S. Patent Application Nos. 2011/0152771; 2010/0220334; 2009/0043191; 2008/0291463; and 2008/0180683, the contents of which are hereby incorporated by reference in their entirety.

Various lumen of biological structures may be imaged with the aforementioned imaging technologies in addition to blood vessels, including, but not limited to, vasculature of the lymphatic and nervous systems, various structures of the gastrointestinal tract including lumen of the small intestine, large intestine, stomach, esophagus, colon, pancreatic duct, bile duct, hepatic duct, lumen of the reproductive tract including the vas deferens, vagina, uterus, and fallopian tubes, structures of the urinary tract including urinary collecting ducts, renal tubules, ureter, bladder, and structures of the head, neck, and pulmonary system including sinuses, parotid, trachea, bronchi, and lungs.

In OCT, a light source delivers a beam of light to an imaging device to image target tissue. Within the light source is an optical amplifier and an tunable filter that allows that allows a user to select a wavelength of light to be amplified. The optical feedback system of the invention can be used to stabilize the selected wavelength of light. Wavelengths commonly used in medical applications include near-infrared light, for example, 800 nm for shallow, high-resolution scans or 1700 nm for deep scans.

Generally, there are two types of OCT systems, common beam path systems and differential beam path systems, which differ from each other based upon the optical layout of the systems. A common beam path system sends all produced light through a single optical fiber to generate a reference signal and a sample signal, whereupon a differential beam path system splits the produced light such that a portion of the light is directed to the sample and the other portion is directed to a reference surface. The reflected light from the sample is recombined with the signal from the reference surface of detection. Common beam path interferometers are further described in, for example, U.S. Pat. Nos. 7,999,938; 7,995,210; and 7,787,127, the contents of which are incorporated by reference herein in its entirety.

In a differential beam path system, amplified light from a light source is inputted into an interferometer with a portion of light directed to a sample and the other portion directed to a reference surface. A distal end of an optical fiber is interfaced with a catheter for interrogation of the target tissue during a catheterization procedure. The reflected light from the tissue is recombined with the signal from the reference surface, forming interference fringes that allow precise depth-resolved imaging of the target tissue on a micron scale. Exemplary differential beam path interferometers are further described in, for example, U.S. Pat. Nos. 6,134,003; and 6,421,164, the contents of which are incorporated by reference herein in its entirety.

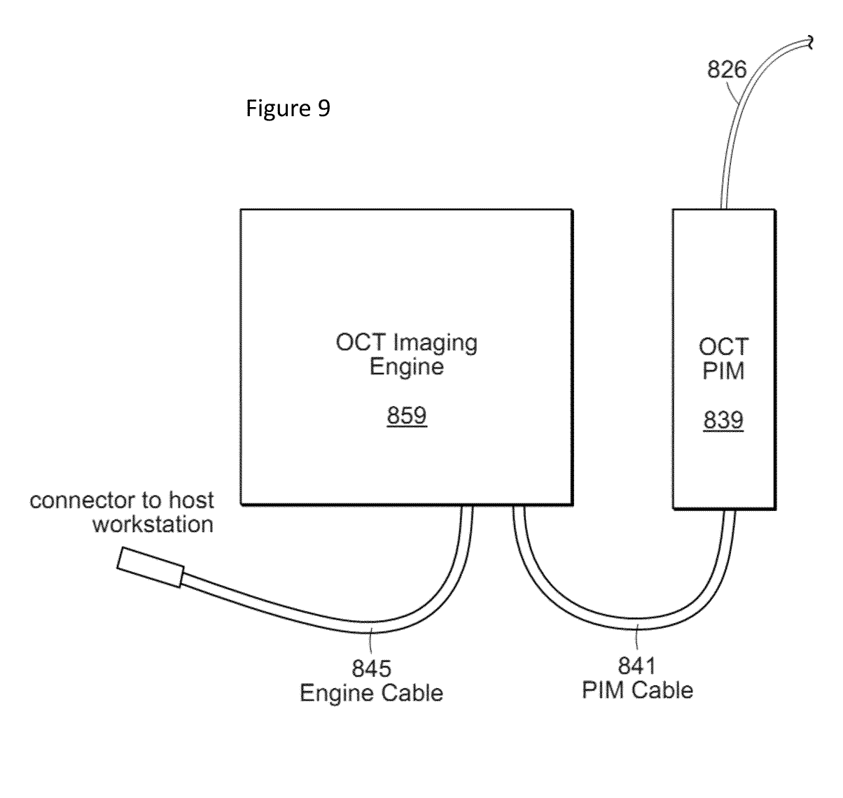

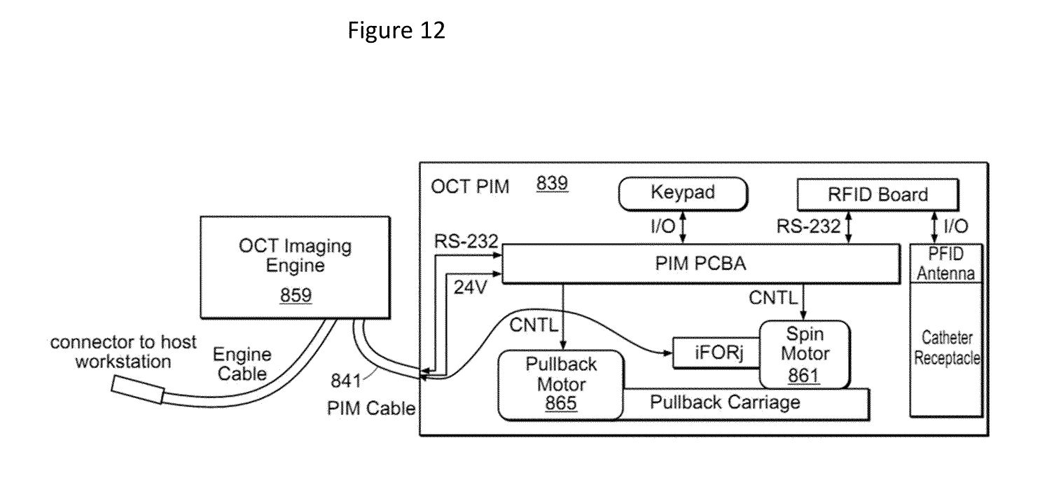

In certain embodiments, the invention can be used in conjunction with a differential beam path OCT system with intravascular imaging capability as illustrated in FIG. 9. In these embodiments, systems and methods of the invention can be used to provide a stabilized light source of a narrow wavelength light. For intravascular imaging, a light beam is delivered to the vessel lumen via a fiber-optic based imaging catheter 826. The imaging catheter is connected through hardware to software on a host workstation. The hardware includes an imaging engine 859 and a handheld patient interface module (PIM) 839 that includes user controls. The proximal end of the imaging catheter is connected to PIM 839, which is connected to an imaging engine as shown in FIG. 12.

As shown in FIG. 12, the imaging engine 859 (e.g., bedside unit) houses a power supply 849, a light source 827 in accordance with the methods and systems described herein, interferometer 931, and variable delay line 835 as well as a data acquisition (DAQ) board 855 and optical controller board (OCB) 854. A PIM cable 841 connects the imaging engine 859 to the PIM 839 and an engine cable 845 connects the imaging engine 859 to the host workstation.

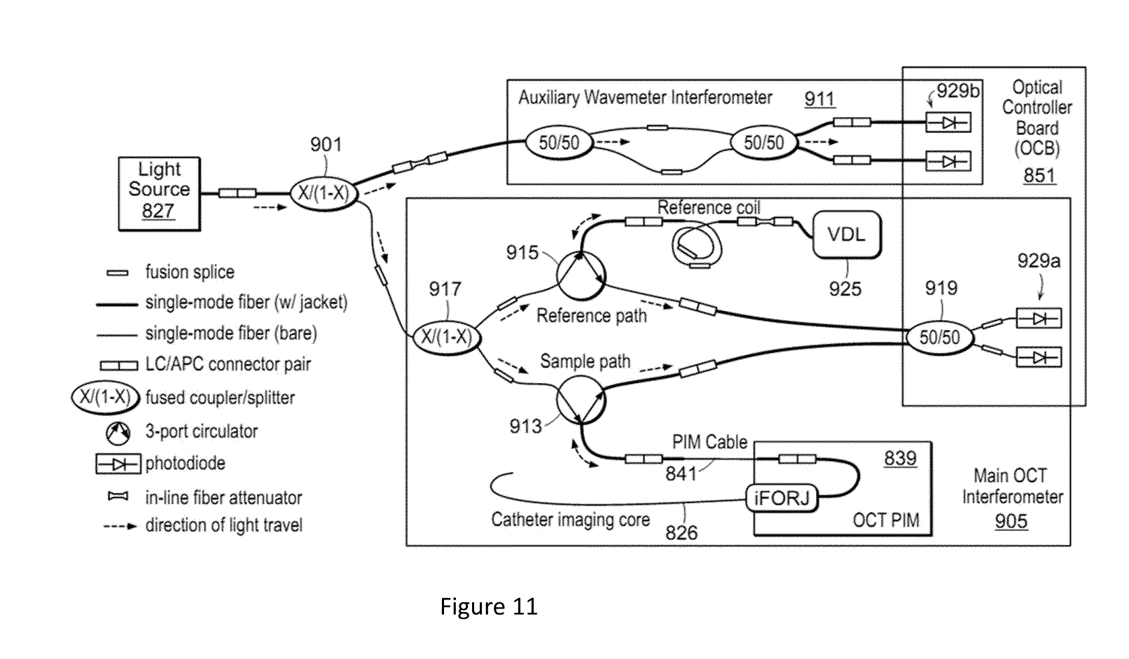

FIG. 11 shows the light path in an exemplary embodiment of the invention. Light for image capture originates within the light source 827. This light is split between an OCT interferometer 905 and an auxiliary interferometer 911. The OCT interferometer generates the OCT image signal and the auxiliary, or “clock” interferometer characterizes the wavelength tuning nonlinearity in the light source and generates a digitizer sample clock.

In certain embodiments, each interferometer is configured in a Mach-Zehnder layout and uses single mode fiber optics to guide the light. Fibers are connected via LC/APC connectors or protected fusion splices. By controlling the split ratio between the OCT and auxiliary interferometers with splitter 901, the optical power in the auxiliary interferometer is controlled to optimize the signal in the auxiliary interferometer. Within the auxiliary interferometer, light is split and recombined by a pair of 50/50 coupler/splitters.

Light directed to the main OCT interferometer is also split by splitter 917 and recombined by splitter 919 with an asymmetric split ratio. The majority of the light is guided into the sample path 913 and the remainder into a reference path 915. The sample path includes optical fibers running through the PIM 839 and the imaging catheter 826 and terminating at the distal end of the imaging catheter 826 where the image is captured.

Typical intravascular OCT involves introducing the imaging catheter into a patients' target vessel using standard interventional techniques and tools such as a guidewire, guide catheter, and angiography system. When operation is triggered from the PIM or control console, the imaging core of the catheter rotates while collecting image data that it delivers to the console screen. Rotation is driven by spin motor 861 while translation is driven by pullback motor 865, as shown in FIG. 12. Blood in the vessel is temporarily flushed with a clear solution while a motor translates the catheter longitudinally through the vessel.

In certain embodiments, the imaging catheter has a crossing profile of 2.4 F (0.8 mm) and transmits focused OCT imaging light to and from the vessel of interest. Embedded microprocessors running firmware in both the PIM and the imaging engine control the system. The imaging catheter includes a rotating and longitudinally-translating inner core contained within an outer sheath. Using light provided by the imaging engine, the inner core detects reflected light. This reflected light is then transmitted along a sample path to be recombined with the light from the reference path.

A variable delay line (VDL) 925 on the reference path uses an adjustable fiber coil to match the length of the reference path 915 to the length of the sample path 913. The reference path length is adjusted by translating a mirror on a lead screw based translation stage that is actuated electromechanically by a small stepper motor. The free-space optical beam on the inside of the VDL 925 experiences more delay as the mirror moves away from the fixed input/output fiber. Stepper movement is under firmware/software control.

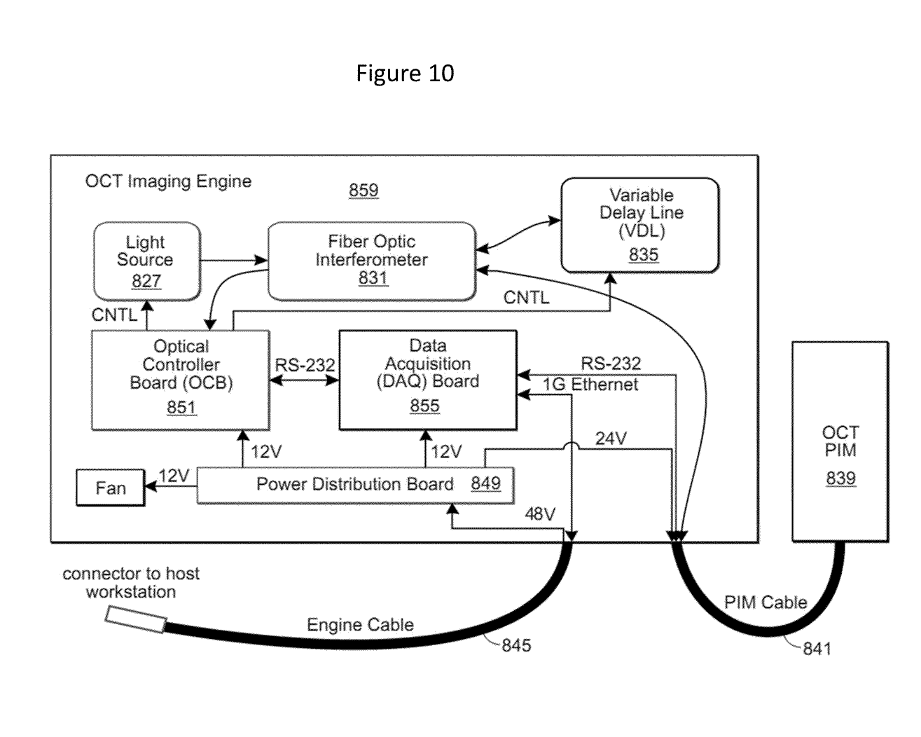

Light from the reference path is combined with light from the sample path. This light is split into orthogonal polarization states, resulting in RF-band polarization-diverse temporal interference fringe signals. The interference fringe signals are converted to photocurrents using PIM photodiodes 929a and 929b on the OCG as shown in FIG. 9. The interfering, polarization splitting, and detection steps are performed by a polarization diversity module (PDM) on the OCB. Signal from the OCB is sent to the DAQ 855, shown in FIG. 10. The DAQ includes a digital signal processing (DSP) microprocessor and a field programmable gate array (FPGA) to digitize signals and communicate with the host work station and the PIM. The FPGA converts raw optical signals into meaningful OCT images. The DAQ also compresses data as necessary to reduce image transfer bandwidth to 1 Gbps.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### Equivalents

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. An optical feedback system, the system comprising:
a gain medium;
a tunable filter operably coupled to the gain medium to produce light of a target wavelength;
a wavelength measuring module coupled to the filter to measure the wavelength of output light and to detect a difference between an output wavelength and the target wavelength; and
a controller operably associated with the wavelength measuring module and the tunable filter for adjusting the output wavelength in response to fluctuations between the output wavelength and the target wavelength by sending a signal directly to said tunable filter.

2. The system of claim 1, wherein the tunable filter comprises a piezoelectric element.

3. The system of claim 2, wherein the tunable filter is a Fabry-Perot filter

4. The system of claim 1, wherein the controller adjusts a voltage sent to a tunable filter.

5. The system of claim 4, wherein the adjusted voltage stabilizes the temperature of the tunable filter.

6. The system of claim 1, wherein the gain medium is an optical amplifier.

7. The system of claim 6, wherein the optical amplifier is a semiconductor optical amplifier.

8. The system of claim 1, further comprising a beam splitter to transmit the outputted light from the tunable filter to the wavelength measuring module, the gain medium, and an output mechanism.

9. The system of claim 8, wherein the output mechanism is coupled to a fiber optic interferometer.

10. A method for providing an optical system with a stabilized light source, the method comprising
filtering light through a tunable filter configured to deliver a target wavelength of light;
measuring the wavelength of the filtered light;
detecting a change between the target wavelength and the filtered wavelength; and
adjusting the tunable filter based on the detected change so that the filtered wavelength matches the target wavelength.

11. The method of claim 10, wherein the tunable filter comprises a piezoelectric element.

12. The method of claim 11, wherein the tunable filter is a Fabry-Perot filter

13. The method of claim 10, wherein the adjusting step comprises adjusting a voltage delivered to the tunable filter.

14. The method of claim 13, wherein the adjusted voltage prevents creep associated with the piezoelectric element.

15. The method of claim 13, wherein the adjusted voltage stabilizes the temperature of the tunable filter.

16. The method of claim 10, further comprising the step of transmitting light from a gain medium to the tunable filter.

17. The method of claim 16, wherein the gain medium is an optical amplifier.

18. The method of claim 17, wherein the optical amplifier is a semiconductor optical amplifier.

19. The method of claim 10, further comprising splitting the filtered light from the tunable filter and directing a beam of the spilt filtered light to an output mechanism.

20. The method of claim 19, wherein the output mechanism is coupled to a fiber optic interferometer.

21. A method for providing an optical system with a stabilized light source, the method comprising
driving a voltage applied to the optical system at a certain frequency, wherein the frequency matches the natural frequency of the optical system.

22. The method of claim 21, the method further comprising subjecting the optical system to the a feedback loop, wherein the feedback loop includes the steps of:
filtering light through a tunable filter configured to deliver a target wavelength of light;
measuring the wavelength of the filtered light;
detecting a change between the target wavelength and the filtered wavelength; and
adjusting the tunable filter based on the detected change so that the filtered wavelength matches the target wavelength.
